(19) United States
(12) Patent Application Publication
(10) Pub. No.: US 2008/0032651 A1
(43) Pub. Date: Feb. 7, 2008

(54) Relay For Multi-Carrier Wireless Communications System

(75) Inventors: Ronald Rietman, Eindhoven (NL); Constant Paul Marie Jozef Baggen, Eindhoven (NL); Franciscus Maria Joannes Willems, Eindhoven (NL); Andries Pieter Hekstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,143

(22) PCT Filed: Sep. 14, 2005
(86) PCT No.: PCT/IB05/53021

§ 371 Date: Mar. 13, 2007

(30) Foreign Application Priority Data
Sep. 17, 2004 (EP) 04104502.2

(51) Int. Cl. H04B 1/16

(52) U.S. Cl. 455/207

(57) ABSTRACT

A relay, for use in an indoor multi-carrier radio frequency wireless communications system, stores multiple predetermined phase adjustment profiles. The best of the stored phase adjustment profiles is selected by a receiver, which sends a message to the relay, indicating the profile to be used. The selected stored phase adjustment profiles is then applied to a multi-carrier signal received at the relay, to form a phase adjusted multi-carrier signal, and this phase adjusted signal is then transmitted from the relay.

This invention relates to a relay, for use in a multi-carrier wireless communications system, and in particular to a relay, which can be used to adjust the phase of the transmitted signals.

Wireless communication systems, based on multi-carrier modulation, are well known.

For example, the IEEE 802.11a standard is becoming widely adopted. This system is based on Orthogonal Frequency Division Multiplexing (OFDM) with 64 sub-carriers.

It is also known that, in a multi-carrier wireless transmission system, a relay can be provided, which receives a signal transmitted from a transmitter, and retransmits the signal for reception by an intended receiver.

EP-A-1039716 discloses a repeater, for use in a broadcast digital terrestrial television system using OFDM. In this repeater, the radio frequency input signal is down converted, and analog-digital converted, to form a complex base band signal. The amplitude and phase of this digital base band signal are then compensated for distortions in the path between the transmitter and the repeater, and the compensated signal is converted into an analog signal and up converted, and then retransmitted from the repeater.

This system has the disadvantage that it requires a large data processing capability in the repeater.

Further, the prior art repeater only seeks to compensate for distortions in the path between the transmitter and the repeater.

According to the present invention, there is provided a relay, which is provided with a memory for storing a plurality of phase adjustment profiles. One of these stored phase adjustment profiles is then applied to a received multi-carrier signal, to form a phase adjusted multi-carrier signal, and this phase-adjusted signal is then transmitted.

This has the advantage that a sufficiently accurate phase adjustment can be provided in order to reduce the probability of errors at the receiver, in particular for short range or indoor transmissions, without requiring large amounts of data processing capacity within the relay.

In a preferred embodiment of the invention, the stored phase adjustment profile is applied to a received multi-carrier signal at radio frequency, to form a phase adjusted multi-carrier signal, and this phase adjusted radio frequency signal is then transmitted.

In a further preferred embodiment of the invention, the stored phase adjustment profile applied to the received multi-carrier signal is selected on the basis of a signal received from a receiver, in order to improve signal reception at the receiver.

According to another aspect of the present invention, there is provided a method of operation of the wireless communications system, in which a plurality of phase adjustment profiles are stored in a relay, and a receiver indicates which of the stored phase adjustment profiles is to be applied to signals. Thereafter, the relay applies the selected stored phase adjustment profile to the received signals, and transmits the adjusted signal to the receiver.

For a better understanding of the present invention, and to show how it may be put into effect, reference will now be made, by way of example, to the accompanying drawings, in which:

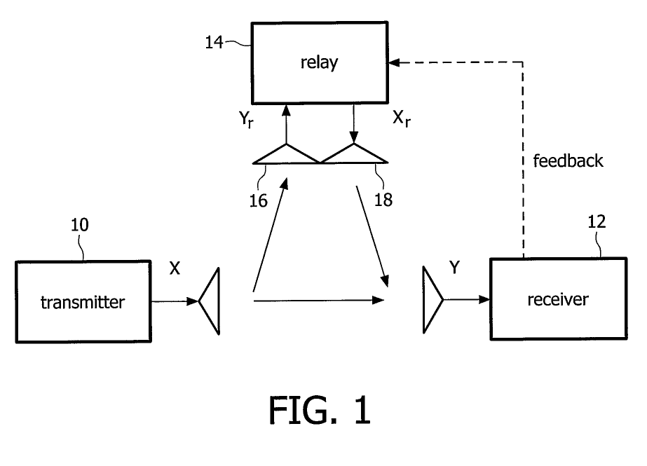

FIG. 1 is a block schematic diagram illustrating a radio communications system in accordance with the present invention.

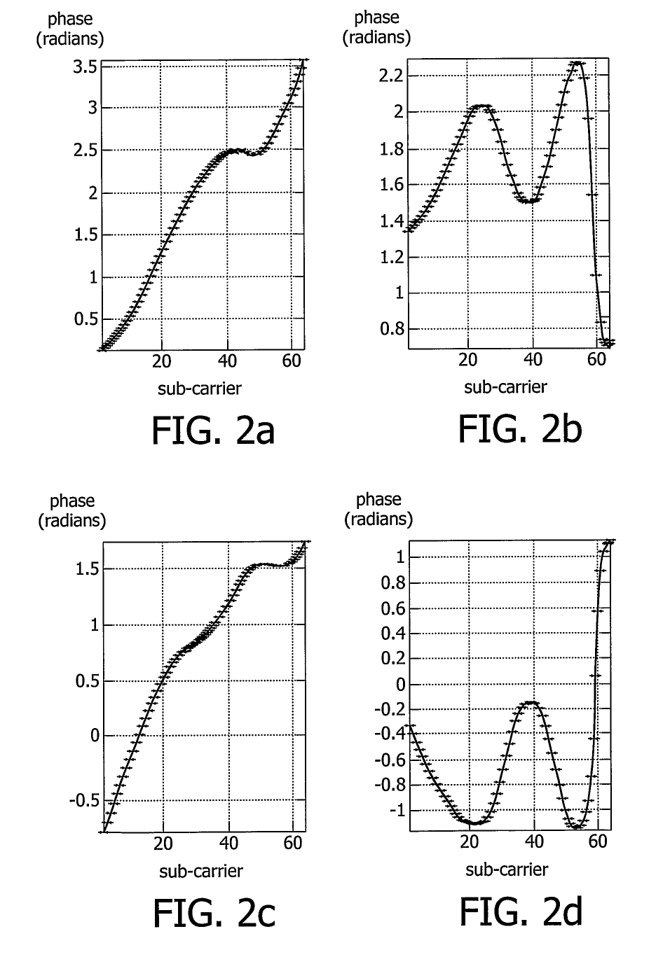

FIG. 2 contains a series of graphs showing the phase characteristics of the transmission paths in the system of FIG. 1.

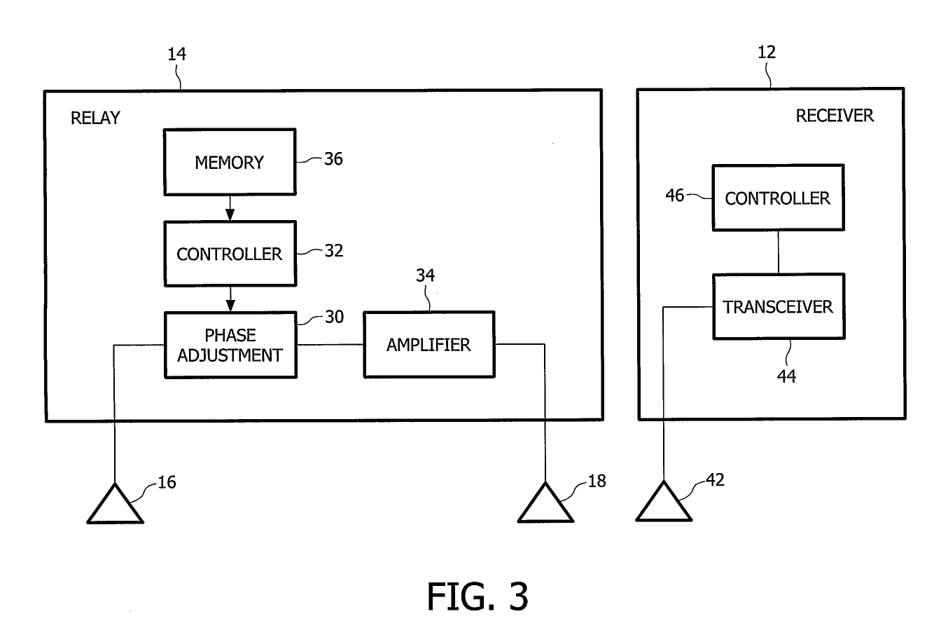

FIG. 3 is a block schematic diagram showing the form of the relay in the system of FIG. 1.

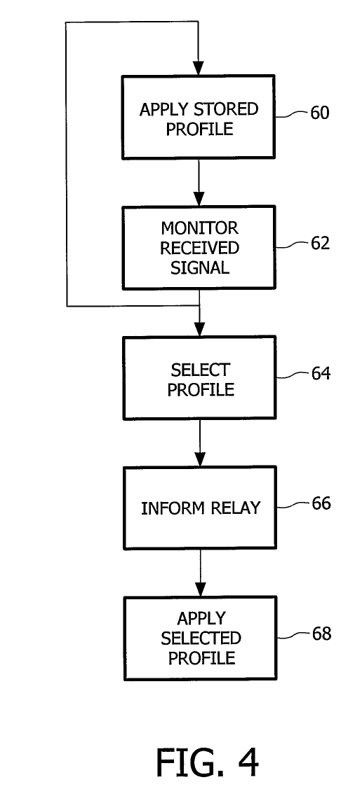

FIG. 4 is a flow chart illustrating a procedure in accordance with an aspect of the present invention.

FIG. 1 is a block schematic diagram, showing the elements of a wireless communications system, operating using OFDM. In this illustrated embodiment of the invention, the system is an indoor multi-carrier transmission system, for example operating under IEEE 802.11a.

A transmitter 10 transmits radio frequency signals to a receiver 12. In addition, because the arrangement of the transmitter 10 and receiver 12 is such that there is a significant probability of errors in the received data, a relay 14 is also provided. For example, this may be because the receiver is located close to the maximum range of the transmitter. However, in the case of an indoor multi-carrier transmission system, it is common for there to be multiple reflections of transmitted signals between the transmitter and the receiver, and the present invention can reduce problems caused by such multiple reflections.

The relay 14 has a receive antenna 16 and a transmit antenna 18, and receives signals transmitted from the transmitter 10, then adjusts those signals to compensate for phase differences in the different transmission paths as described in more detail below, and then retransmits the adjusted signals for reception by the receiver 12.

FIG. 2 shows in more detail the phase characteristics of the transmission paths in the system of FIG. 1, with each of FIGS. 2(a)-(b) showing the phase shifts for each of the 64 available sub-carriers.

Thus, FIG. 2(a) shows the phase characteristic for the transmission path from the transmitter 10 to the receiver 12, that is, the transmission path X-Y in FIG. 1. FIG. 2(b) shows the phase characteristic of the transmission path from the transmitter 10 to the relay 14, that is, for the transmission path X-Yᵣ in FIG. 1. FIG. 2(c) shows the phase characteristic of the phase transmission path from the relay 14 to the receiver 12, that is, for the transmission path Xᵣ-Y in FIG. 1.

FIG. 2(d) then shows the difference between the direct path X-Y from the transmitter 10 to the receiver 12, and the indirect path X-Yᵣ, Xᵣ-Y.

Ideally, there should be no phase difference between the direct path and the indirect path. This would have the consequence that the signal transmitter over the indirect path would add constructively to the signal transmitted over the direct path, increasing the signal strength of the received signals at the receiver 12, and allowing the receiver 12 to detect the transmitted data with a lower probability of error.

In order to achieve this, the relay 14 would need to apply a phase compensation which exactly cancelled out the phase difference characteristic shown in FIG. 2(d).

However, it has now been found that a significant reduction in the probability of an error in recovering the transmitted data in the receiver 12 can be achieved by applying much simpler phase compensation.

FIG. 3 is a block schematic diagram showing in more detail the form of the relay 14 and the receiver 12 for achieving this improvement. Thus, FIG. 3 shows the relay 14, having a receive antenna 16 and a transmitter antenna 18, as previously discussed.

Received signals are passed from the receive antenna 16 to a controllable phase adjustment block 30, which operates under the control of a controller 32, as will be discussed in more detail below. The phase adjusted signals are passed to a power amplifier 34, and the amplified signals are passed to the transmit antenna 18.

The receiver 12 includes an antenna 42, and transceiver circuitry 44, which are generally conventional, and a controller 46.

As discussed above, an appropriate phase adjustment, implemented in the controllable phase adjustment block 30, will increase the probability that the signals transmitted from the relay 14 will interfere constructively with the signals transmitted directly from the transmitter 10, when they are received at the receiver 12, and will thereby reduce the probability that there will be errors in the data detected by the receiver 12. However, in accordance with the present invention, the controller 32 does not attempt to determine the ideal phase adjustment profile, to be applied to the different sub-carriers in the phase adjustment block 30.

Rather, the controller 32 retrieves a selected pre-stored phase adjustment profile from a memory 36, and then controls the phase adjustment block 30 to apply this stored phase adjustment profile to the sub-carriers of the signal received at the antenna 16.

FIG. 4 is a flow chart illustrating the procedure followed in the relay 14 and the receiver 12. The procedure illustrated in FIG. 4 is preferably performed during the initialization of a connection from the transmitter 10 to the receiver 12. Thereafter, the procedure may be performed again during the connection, either at predetermined intervals, or when it is determined that changes in the environment have caused the quality of the connection to become unsatisfactory.

In step 60, the relay receives a signal from the transmitter 10, and applies one of the stored phase adjustment profiles to the received signal. The available stored phase adjustment profiles are described in more detail below.

In step 62, the controller 46 in receiver 12 monitors the quality of the received signal. As will be appreciated, this received signal results from the superposition of the signals received on the direct path from the transmitter 10 and on the indirect path from the relay 14.

Steps 60 and 62 are repeated until the relay 14 has applied all of the stored phase adjustment profiles in turn. For example, there may be from four to eight stored phase adjustment profiles. Alternatively, if it is determined that one of the phase adjustment profiles produces an acceptable signal quality, the algorithm may then proceed without testing all of the stored phase adjustment profiles.

Then, in step 64, the receiver 64 determines which of the applied phase adjustment profiles has produced the best quality of the received signal. Numerous conventional techniques exist for monitoring the quality of received signals, and the best signal can be selected on the basis of any desired criteria.

In step 66, the receiver 12 sends a signal to the relay 14, informing it of the selected phase adjustment profile that has produced the best quality of the received signal. Devices operating under IEEE 802.11 are capable of sending and receiving data, and so the receiver 12 is able to send a signal to the relay 14 using this protocol.

In step 68, the relay 14 acts on the message received from the receiver 12, and thereafter applies the selected phase adjustment profile to all signals received from the transmitter 10.

In a first embodiment of the present invention, the phase adjustment block 30 applies an equal phase adjustment to each of the 64 sub-carriers.

Further, in this preferred embodiment of the invention, the memory 36 contains four stored phase adjustment profiles. According to a first of these stored profiles, no phase shift is applied to any of the sub-carriers. According to a second profile, a phase shift of π/2 is applied to each of the 64 sub-carriers. According to a third profile, a phase shift of π is applied to each of the 64 sub-carriers. According to a fourth profile, a phase shift of 3π/2 is applied to each of the 64 sub-carriers.

Based on feedback from the receiver 12, the controller 32 selects the best of these stored profiles, and controls the phase adjustment block 30 to apply this profile to the sub-carriers of the received signal.

According to a second embodiment of the invention, the phase adjustment block 30 applies a constant time delay to each of the 64 sub-carriers. As would be appreciated by the person skilled in the art, an equal time delay, applied to all 64 sub-carriers, amounts to a phase delay which varies linearly across the 64 sub-carriers. In this case, the phase adjustment block 30 may comprise a tapped delay line, which can be tapped at different points to provide different delays. The selection of a delay then amounts to selecting one of these points.

According to a third embodiment of the present invention, the memory 36 contains a plurality of stored pseudo-random profiles. According to each of these stored profiles, a particular phase delay is applied to each of the sub-carriers, such that they form profiles which generally resemble that shown in FIG. 2(d). That is, in each of the stored profiles, the phase adjustment varies in a continuous manner over the 64 sub-channels, but there need not be any other similarity between the various stored profiles. For example, in one or more of the stored profiles, the phase adjustment may be monotonically increasing or decreasing over the sub-channels, while in one or more other stored profiles, it may resemble a sine wave.

As discussed above, the controller 32 selects the best of the stored profiles, based on feedback from the receiver, and the phase adjustment block applies the desired phase adjustment to the received signals.

In the embodiments described above, the receiver 12 identifies the best of the stored profiles, at during an initialization period, by receiving signals to which the stored profiles have been applied, and then selecting the profile which leads to the best received signal. However, it is also possible that the receiver 12 could obtain information relating to the direct transmitter-receiver channel, and the indirect relay-receiver channel. Based on such information, the receiver could determine theoretically which of the stored profiles would lead to the best result, and could then send a message to the relay 14 requesting that that stored profile be applied.

The invention has been described above, with reference to an embodiment in which the phase adjustment is applied directly to the received signals, without requiring digitization of the received signals, and down conversion to base band. However, it would also be possible to down convert the received signals to an intermediate radio frequency, and then to apply the phase adjustment to the down converted received signals, and then up convert the phase adjusted signals to their original frequency for transmission. It would also be possible to down convert the received signals to base band, and then to apply the phase adjustment to the down converted received signals, and then up convert the phase adjusted signals to their original frequency for transmission, provided that the relay is able to perform the required processing within the available time period.

1. A relay, comprising:
means for receiving a multi-carrier signal;
means for storing a plurality of phase adjustment profiles;
means for applying to the received multi-carrier signal a selected one of the stored phase adjustment profiles, to form a phase adjusted multi-carrier signal; and
means for transmitting the phase adjusted multi-carrier signal.

2. A relay as claimed in claim 1, comprising means for applying the selected one of the stored phase adjustment profiles to the received signal, at a radio frequency.

3. A relay as claimed in claim 2, comprising means for applying the selected one of the stored phase adjustment profiles to the received signal, at a frequency of the received signal.

4. A relay as claimed in claim 2, comprising:
means for down converting the received signal from a first radio frequency to a second radio frequency;
means for applying the selected one of the stored phase adjustment profiles to the received signal at the second radio frequency; and
means for up converting the phase adjusted signal from the second radio frequency to the second radio frequency.

5. A relay as claimed in claim 1, comprising:
means for receiving a message from a receiver of the transmitted phase adjusted multi-carrier signal; and
means for selecting the one of the stored phase adjustment profiles on the basis of said message.

6. A relay as claimed in claim 1, wherein the multi-carrier signal comprises a plurality of sub-carriers, and, according to a plurality of stored phase adjustment profiles, a respective constant phase adjustment is applied to each of the sub-carriers.

7. A relay as claimed in claim 1, wherein the multi-carrier signal comprises a plurality of sub-carriers, and, according to a plurality of stored phase adjustment profiles, a respective constant delay is applied to each of the sub-carriers.

8. A wireless communications system, comprising:
a receiver, for receiving multi-carrier signals transmitted from a transmitter; and
a relay, for receiving said multi-carrier signals transmitted from the transmitter;
wherein the relay is adapted to store a plurality of phase adjustment profiles;
wherein the receiver is adapted to select one of said stored phase adjustment profiles, and to send a message to the relay identifying the selected one of said stored phase adjustment profiles; and
wherein the relay is adapted to apply to the selected one of the stored phase adjustment profiles to the received multi-carrier signals, and to transmit the phase adjusted multi-carrier signals.

9. A wireless communications system as claimed in claim 8, wherein the relay is adapted during an initialization period to apply to the stored phase adjustment profiles to the received multi-carrier signals in turn, and to transmit the phase adjusted multi-carrier signals; and the receiver is adapted to select one of said stored phase adjustment profiles on the basis of a signal quality of received signals during said initialization period.

10. A method of transmitting data from a transmitter to a receiver in a multi-carrier wireless communications system, the method comprising:
receiving a multi-carrier signal containing transmitted data in a relay;
applying to the received multi-carrier signal a selected one of a plurality of stored phase adjustment profiles, to form a phase adjusted multi-carrier signal; and
transmitting the phase adjusted multi-carrier signal to the receiver.

11. A method as claimed in claim 10, comprising applying the selected one of the stored phase adjustment profiles to the received signal, at a radio frequency.

12. A method as claimed in claim 11, comprising applying the selected one of the stored phase adjustment profiles to the received signal, at a frequency of the received signal.

13. A method as claimed in claim 11, comprising:
down converting the received signal from a first radio frequency to a second radio frequency;
applying the selected one of the stored phase adjustment profiles to the received signal at the second radio frequency; and
up converting the phase adjusted signal from the second radio frequency to the second radio frequency.

14. A method as claimed in claim 10, comprising:
receiving a message from a receiver of the transmitted phase adjusted multi-carrier signal; and
selecting the one of the stored phase adjustment profiles on the basis of said message.

15. A method as claimed in claim 10, wherein the multi-carrier signal comprises a plurality of sub-carriers, and, according to a plurality of stored phase adjustment profiles, a respective constant phase adjustment is applied to each of the sub-carriers.

16. A method as claimed in claim 10, wherein the multi-carrier signal comprises a plurality of sub-carriers, and, according to a plurality of stored phase adjustment profiles, a respective constant delay is applied to each of the sub-carriers.

17. A method as claimed in claim 10, comprising:
in said receiver, selecting one of said stored phase adjustment profiles, and sending a message to the relay identifying the selected one of said stored phase adjustment profiles; and
in said relay, applying the selected one of the stored phase adjustment profiles to the received multi-carrier signals, and transmitting the phase adjusted multi-carrier signals.

18. A method as claimed in claim 17, comprising:
in said relay, during an initialization period, applying the stored phase adjustment profiles to the received multi-carrier signals in turn, and transmitting the respective phase adjusted multi-carrier signals; and
in said receiver, selecting one of said stored phase adjustment profiles on the basis of a signal quality of received signals during said initialization period.
